(19) United States
(12) Patent Application Publication
(10) Pub. No.: US 2009/0125452 A1
(43) Pub. Date: May 14, 2009

(54) Currency Strength Indexes

(75) Inventor: Milan Kratka, Clarendon Hills, IL (US)

Correspondence Address: MCANDREWS HELD & MALLOY, LTD, 500 WEST MADISON STREET, SUITE 3400, CHICAGO, IL, 60661, US

(73) Assignee: Sun Trading LLC, Chicago, IL (US)

(21) Appl. No.: 12/270,589

(22) Filed: Nov. 13, 2008

Related U.S. Application Data
(60) Provisional application No. 61/002,821, filed on Nov. 13, 2007.

(51) Int. Cl. G06Q 40/00

(52) U.S. Cl. 705/36 R

(57) ABSTRACT

Systems, methods and computer instructions for creating and/or determining the present value of currency strength indexes are provided. Certain methods of using a computer to create a currency index include: selecting a basis currency; selecting a plurality of non-basis currencies; assigning an allocation to each non-basis currency; and making an investment transaction for each non-basis currency based at least in part on the allocation. In certain methods, the investment transaction includes selling an amount of each non-basis currency against the basis currency. In certain methods, the investment transaction includes buying an amount of each non-basis currency against the basis currency. Certain methods include determining the present value of the currency index.

### RELATED APPLICATIONS

This application claims priority to U.S. Provisional Application No. 61/002,821 filed Nov. 13, 2007, entitled CURRENCY STRENGTH INDEXES, which application is incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

Embodiments of the present technology relate to creation and maintenance of currency indexes that may form the basis of tradable financial products and investment vehicles, such as futures, forwards, options, and exchange-traded funds, for example.

Exchange rates among the world's currencies are constantly in flux. Currency indexes that track such fluctuations have been proposed. For example, known currency indexes include the G-10 (Group of Ten) index maintained by the Board of Governors of the U.S. Federal Reserve System and the currency index described in U.S. Patent Application Publication No. 2004/0098334 by Brusso et al., which was published on May 20, 2004.

However, known indexes can be complicated and may not be desirable to form the basis of tradable financial products and investment vehicles, such as futures, forwards, options, and exchange-traded funds, for example. Systems and methods that provide for creation and maintenance of improved currency indexes are therefore desirable.

### BRIEF SUMMARY

Embodiments of the present technology provide systems, methods and computer instructions for creating and/or determining the present value of currency strength indexes.

Certain embodiments provide a method of using a computer to create a currency index that includes: selecting a basis currency; selecting a plurality of non-basis currencies; assigning an allocation to each non-basis currency; and making an investment transaction for each non-basis currency based at least in part on the allocation.

Certain embodiments provide a method of using a computer to determine the present value of a currency index of a basis currency against a plurality of non-basis currencies, wherein an investment transaction for each non-basis currency was initially made, the method including: applying the following equation to determine the present value of the currency index (CI(t)):

$$C I ( t ) = {\sum }_{i = 1}^{X} w ( i ) * \frac{Rate ( i , t )}{Rate ( i , 0 )} ,$$

wherein x is the number of non-basis currencies, wherein w(i) is an amount of an initial investment transaction for the i-th non-basis currency, wherein Rate(i, 0) is an exchange rate for the basis currency and the i-th non-basis currency when the initial investment transaction occurred, and wherein Rate(i, t) is a present exchange rate for the basis currency and the i-th non-basis currency.

Certain embodiments provide a computer-readable storage medium encoded with a set of instructions for execution on a processing device and associated processing logic for determining the present value of a currency index of a basis currency against a plurality of non-basis currencies, wherein an investment transaction for each non-basis currency was initially made, the set of instructions including: a routine that allows the following equation to be applied to determine the present value of the currency index (CI(t)) where:

$$C I ( t ) = {\sum }_{i = 1}^{X} w ( i ) * \frac{Rate ( i , t )}{Rate ( i , 0 )} ,$$

wherein x is the number of non-basis currencies, wherein w(i) is an amount of an initial investment transaction for the i-th non-basis currency, wherein Rate(i, 0) is an exchange rate for the basis currency and the i-th non-basis currency when the initial investment transaction occurred, and wherein Rate(i, t) is a present exchange rate for the basis currency and the i-th non-basis currency.

### BRIEF DESCRIPTION OF THE DRAWINGS

FIG. 1 is a flow diagram that illustrates a method used in accordance with an embodiment of the present technology.

FIG. 2 depicts an information system used in accordance with an embodiment of the present technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Embodiments of the present technology address points arising in relative valuation of a particular currency with respect to other currencies in a marketplace. Relative strength of one currency with respect to another currency is measured by their exchange rate. For instance, one U.S. dollar can be exchanged for some amount of British pounds. This relative value is an indication of strength of United States currency relative to the currency of the United Kingdom. Similarly, one U.S. dollar can be exchanged for some amount of Japanese yen. And so on. These exchange rates can fluctuate, and one can observe their fluctuation over time.

Embodiments of the present technology provide systems, methods and computer instructions for creating and maintaining currency indexes. Currency strength indexes (CSI) that can provide the strength of a currency relative to other currencies are provided. Currency weakness indexes (CWI) that can provide the weakness of a currency relative to other currencies are also provided. In certain embodiments, such currency indexes can be utilized to create tradable financial products and investment vehicles, such as futures, forwards, options, and exchange-traded funds, for example.

Certain embodiments of the present technology differ from known techniques, for example, in that creating and/or determining the present value of a currency index: (1) is based on calculating relative value of a currency index based on the value of investment in long and short positions in other currencies; (2) depends on the value of simple currency exchange rates; (3) is linear based on the currencies in the index; (4) requires no complex calculations of geometric, weighted geometric averages, or any other averaging in calculating the indexes; (5) measures strength and weakness of a basis currency in terms of the basis currency; (6) allows for using currency exchange readily available exchange rates; (7) allows for using any relative allocation criteria, for instance those based on gross domestic product (GDP), international trade volume, exchange trading volume, and/or any criteria deemed suitable; (8) can include reallocation of currencies in the index (e.g., if allocations are changed, currencies are deleted from an index, and/or new currencies are added to an index) in the same manner in which the index was created, such that no multipliers or fudge factors are needed after rebalancing to keep the index continuous; and/or (9) allows for fluctuation in relative value of one particular currency to affect the index proportionally only to the allocated size of the currency.

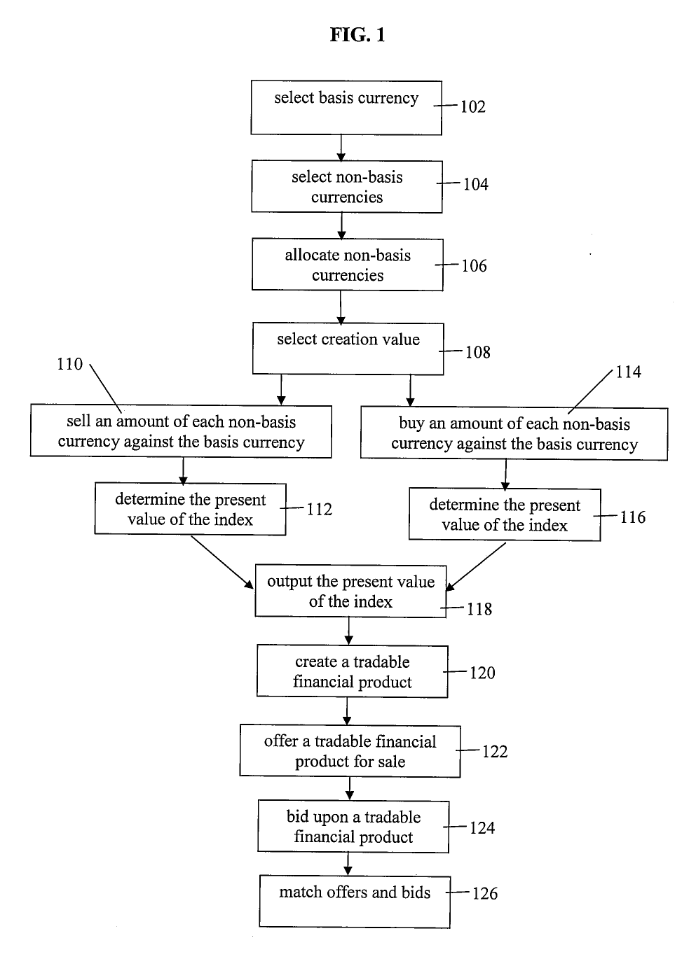

FIG. 1 is a flow diagram that illustrates a method 100 used in accordance with an embodiment of the present technology. At 102, a currency is selected to be the basis currency of an index. For example, U.S. dollars, or any other currency, can be selected to be the basis currency of the index. In certain embodiments, the basis currency can be selected manually, for example, using a user interface in communication with an input device, such as a mouse, keypad, keyboard, etc. In certain embodiments, the basis currency can be selected automatically, for example, using a processor in communication with a database that includes currencies.

At 104, non-basis currencies (i.e., currencies that are not the basis currency) are selected to be part of the index. For example, European Union euros, Chinese Yuan (RMB), Mexican pesos, Swedish kronas, etc. can be selected. In certain embodiments, any of the world's currencies that are not the basis currency can be selected. In certain embodiments, currencies can be selected manually, for example, using a user interface in communication with an input device, such as a mouse, keypad, keyboard, etc. In certain embodiments, currencies can be selected automatically, for example, using a processor in communication with a database that includes a list of currencies.

At 106, selected non-basis currencies are allocated. For example, each selected non-basis currency can be assigned an allocation that represents a percentage of the group. For example, if four non-basis currencies are selected, each non-basis currency could be allocated 25%. As another example, if four non-basis currencies are selected, two non-basis currencies could be allocated 40% and two non-basis currencies could be allocated 10%. Any desirable allocation can be used. For example, in certain embodiments, relative gross domestic product (GDP), international trade volume and/or exchange trading volume can be used to determine allocation. For example, if the GDP of a first country is twice as large as the GDP of a second country, the currency of the first country can have an allocation that is twice as large as the allocation of the currency of the second country. In certain embodiments, allocations can be selected manually, for example, using a user interface in communication with an input device, such as a mouse, keypad, keyboard, etc. In certain embodiments, allocations can be selected automatically, for example, using a processor in communication with a database that includes allocation information.

At 108, a creation value for the index is selected. For example, at the time the index is created a value, such as 100 U.S. dollars or any other amount in any other currency, for example, can be selected. In certain embodiments, the creation value can be selected manually, for example, using a user interface in communication with an input device, such as a mouse, keypad, keyboard, etc. In certain embodiments, the creation value can be selected automatically, for example, using a processor in communication with a database that includes creation value information.

At 110, the creation value is invested by selling each non-basis currency against the basis currency according to the allocation of the non-basis currencies, thereby creating a CSI. For example, if the basis currency is U.S. dollars, the creation value is 100 U.S. dollars, and the non-basis currencies are European Union euros allocated 23%, Chinese Yuan (RMB) allocated 50%, Mexican pesos allocated 10% and Swedish kronas allocated 17%, then each non-basis currency is sold against U.S. dollars according to the allocation such that 23 U.S. dollars worth of European Union euros are sold against the U.S. dollar, 50 U.S. dollars worth of Chinese Yuan (RMB) are sold against the U.S. dollar, 10 U.S. dollars worth of Mexican pesos are sold against the U.S. dollar, and 17 U.S. dollars worth of Swedish kronas are sold against the U.S. dollar. The created index is a CSI of the U.S. dollar against European Union euros, Chinese Yuan (RMB), Mexican pesos and Swedish kronas. In certain embodiments, the investing can be achieved manually and/or automatically using a computing device with a processor configured to send and receive investment information to and from a database(s) and/or existing investment systems.

At 112, the present value of the CSI of 110 is determined. For example, the following equation can be applied to determine the present value of the CSI (i.e., CSI(t)):

$$CSI ( t ) = {\sum }_{i = 1}^{X} w ( i ) * \frac{ExRate ( i , t )}{ExRate ( i , 0 )} ,$$

where x is the number of non-basis currencies, w(i) is the allocated value for the non-basis currency of the i-th currency at the time of the initial investment, ExRate(i, 0) is the exchange rate of the basis currency with respect to the i-th non-basis currency at the time of the initial investment, and ExRate(i, t) is the exchange rate of the basis currency with respect to the i-th non-basis currency at time t. For example, if the basis currency is U.S. dollars, and the individual dollar exchange rates (ExRate(i, t)) increase over time, meaning that the strength of the U.S. dollar versus the non-basis currencies has increased, then the value of the index, measured in U.S. dollars (CSI(t)), will increase. On the other hand, if the individual dollar exchange rates (ExRate(i, t)) decrease over time, meaning that the strength of the U.S. dollar versus the non-basis currencies has decreased, then the value of the index, measured in U.S. dollars (CSI(t)), will decrease. In certain embodiments, determining the present value of a CSI can be achieved manually and/or automatically using a computing device with a processor configured to send and receive investment and/or exchange rate information to and from a database(s) and/or existing investment systems.

As mentioned above, at 110, the created index is a CSI of the basis currency against the non-basis currencies (i.e., where the creation value is invested by selling an amount of each non-basis currency against the basis currency). In certain situations, it may be desirable to create an index that is a CWI (i.e., where the creation value is invested by buying an amount of each non-basis currency against the basis currency), because, for example, selling of the non-basis currency against the basis currency may not be available. Creation of such a CWI is described below.

At 114, the creation value is invested by buying each non-basis currency against the basis currency according to the allocation of the non-basis currencies, thereby creating a CWI. For example, if the basis currency is U.S. dollars, the creation value is 100 U.S. dollars, and the non-basis currencies are European Union euros allocated 23%, Chinese Yuan (RMB) allocated 50%, Mexican pesos allocated 10% and Swedish kronas allocated 17%, then each non-basis currency is bought against U.S. dollars according to the allocation such that 23 U.S. dollars worth of European Union euros are bought against the U.S. dollar, 50 U.S. dollars worth of Chinese Yuan (RMB) are bought against the U.S. dollar, 10 U.S. dollars worth of Mexican pesos are bought against the U.S. dollar, and 17 U.S. dollars worth of Swedish kronas are bought against the U.S. dollar. The created index is a CWI of the U.S. dollar against Euros, Chinese Yuan (RMB), Mexican pesos and Swedish kronas. In certain embodiments, the investing can be achieved manually and/or automatically using a computing device with a processor configured to send and receive investment information to and from a database(s) and/or existing investment systems.

At 116, the present value of the CWI of 114 is determined. For example, the following equation can be applied to determine the present value of the CWI (i.e., CWI(t)):

$$CWI ( t ) = {\sum }_{i = 1}^{X} w ( i ) * \frac{FxRate ( i , t )}{FxRate ( i , 0 )} ,$$

where x is the number of non-basis currencies, w(i) is the allocated value for the non-basis currency of the i-th currency at the time of the initial investment, FxRate(i, 0) is the exchange rate of the i-th non-basis currency with respect to the basis currency at the time of the initial investment, and FxRate(i, t) is the exchange rate of the i-th non-basis currency with respect to the basis currency at time t. For example, if the basis currency is U.S. dollars, and the individual foreign exchange rates (FxRate(i, t)) increase over time, meaning that the strength of the U.S. dollar versus the non-basis currencies has decreased, then the value of the index, measured in U.S. dollars (CWI(t)), will increase. On the other hand, if the individual foreign exchange rates (FxRate(i, t)) decrease over time, meaning that the strength of the U.S. dollar versus the non-basis currencies has increased, then the value of the index, measured in U.S. dollars (CWI(t)), will decrease. Notably, in certain embodiments, a foreign exchange rate can be inversely proportional to a domestic exchange rate, such that

$$FxRate ( i , t ) = \frac{1}{ExRate ( i , t )} .$$

For this reason, a currency weakness index can be referred to as an anti-index. In certain embodiments, determining the present value of a CWI can be achieved manually and/or automatically using a computing device with a processor configured to send and receive investment and/or exchange rate information to and from a database(s) and/or existing investment systems.

At 118, the present value of the index is output. For example, the present value of an index can be output as: a visual display on a user interface, printed matter, and/or a write command to a database, for example.

At 120, a tradable financial product and/or an investment vehicle can be created based on an index. In certain embodiments, a tradable financial product and/or an investment vehicle can include a future, forward, option, and/or an exchange-traded fund, for example. In certain embodiments, creating a tradable financial product and/or an investment vehicle can be achieved manually and/or automatically using a computing device with a processor configured to send and receive information to and from a database(s) and/or existing investment systems.

At 122, the tradable financial product and/or investment vehicle can be offered for sale. In certain embodiments, offering a tradable financial product and/or an investment vehicle for sale can be achieved manually and/or automatically using a computing device with a processor configured to send and receive information to and from a database(s) and/or existing investment systems.

At 124, the tradable financial product and/or investment vehicle can be bid upon. In certain embodiments, bidding upon a tradable financial product and/or an investment vehicle can be achieved manually and/or automatically using a computing device with a processor configured to send and receive information to and from a database(s) and/or existing investment systems.

At 126, the offers and bids are matched. In certain embodiments, matching bids and offers can be achieved manually and/or automatically using a computing device with a processor configured to send and receive information to and from a database(s) and/or existing investment systems.

One or more of the steps of the method 100 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. For example, certain embodiments provide a computer-readable storage medium encoded with a set of instructions for execution on a processing device and associated processing logic, wherein the set of instructions includes a routine(s) configured to provide the functions described in connection with the methods 100 described in connection with FIG. 1.

Certain embodiments of the present invention may omit one or more of the steps of method 100 and/or perform the steps in a different order than the order listed. For example, some steps may not be performed in certain embodiments of the present invention. As a further example, certain steps may be performed in a different temporal order, including simultaneously, than listed above.

In certain embodiments, the non-basis currencies in an index can be modified, for example, by: (1) changing the allocation of the present non-basis currencies; (2) deleting a currency from the index; and/or (3) adding a new currency to the index. In order to do so, the present value of the index is simply redistributed based on the desired allocation in the same manner in which the original index was created (i.e., by buying or selling an amount of each non-basis currency against the basis currency according to the desired allocation of the non-basis currencies).

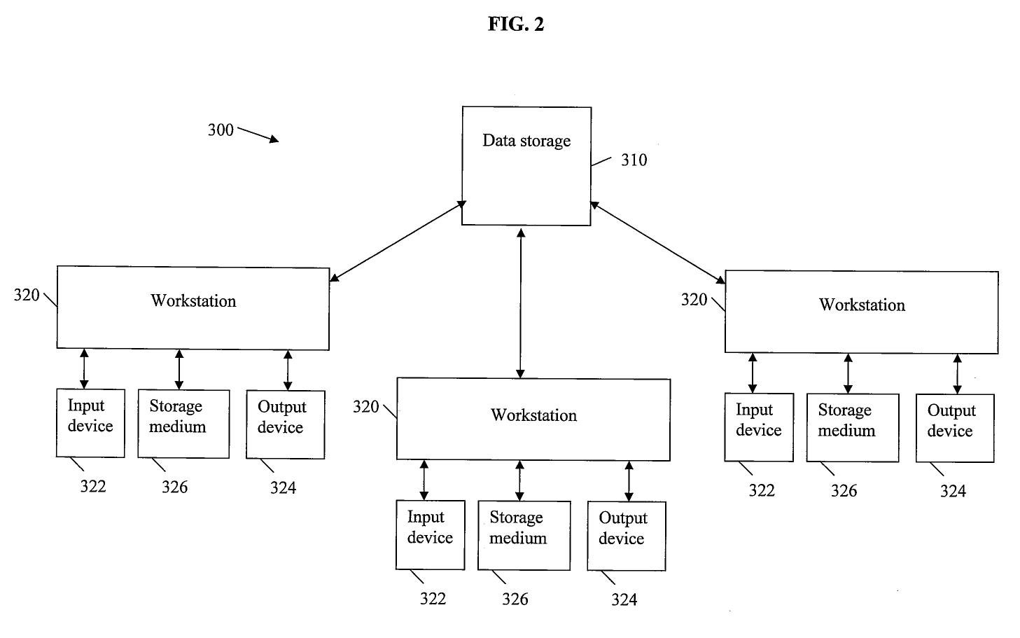

FIG. 2 depicts an information system 300 used in accordance with an embodiment of the present technology. Certain embodiments of the method 100 described above can be implemented on an information system, such as the system 300. In certain embodiments, the method 100 described above can be implemented in connection with a trading system that allows tradable financial products and investment vehicles, such as futures, forwards, options, and exchange-traded funds, for example, to be traded.

In certain embodiments, an interface may be viewed and/or constructed using a system such as system 300 including at least one data storage 310 and at least one workstation 320. While three workstations 320 are illustrated in system 300, a larger or smaller number of workstations 320 can be used in accordance with embodiments of the presently described technology. In addition, while one data storage 310 is illustrated in system 300, system 300 can include more than one data storage 310. For example, each of a plurality of entities (such as remote data storage facilities) can each include one or more data stores 310 in communication with one or more workstations 320. Workstations 320 can be personal computers, wireless devices, such as telephones, for example, and/or host attached terminals, for example. Workstations 320 include an input device 322, an output device 324 and a storage medium 326. For example, workstations 320 can include a mouse, stylus, microphone and/or keyboard as an input device. Workstations 320 can include a computer monitor, liquid crystal display (“LCD”) screen, printer and/or speaker as an output device. Storage medium 326 of workstations 320 is a computer-readable memory. For example, storage medium 326 can include a computer hard drive, a compact disc (“CD”) drive, a USB thumb drive, or any other type of memory capable of storing one or more computer software applications. Storage medium 326 can be included in workstations 320 or physically remote from workstations 320. For example, storage medium 326 can be accessible by workstations 320 through a wired or wireless network connection.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method of using a computer to create a currency index comprising:
selecting a basis currency;
selecting a plurality of non-basis currencies;
assigning an allocation to each non-basis currency; and
making an investment transaction for each non-basis currency based at least in part on the allocation.

2. The method of claim 1, wherein the investment transaction includes selling an amount of each non-basis currency against the basis currency.

3. The method of claim 2, further including determining the present value of the currency index.

4. The method of claim 3, wherein determining the present value of the currency index (CSI(t)) includes applying the following equation:
$$CSI ( t ) = {\sum }_{i = 1}^{X} w ( i ) * \frac{ExRate ( i , t )}{ExRate ( i , 0 )} ,$$
wherein x is the number of non-basis currencies, wherein w(i) is the amount of i-th non-basis currency sold, wherein ExRate(i, 0) is an exchange rate of the basis currency with respect to the i-th non-basis currency when the amount of the non-basis currency was sold, and wherein ExRate(i, t) is a present exchange rate of the basis currency with respect to the i-th non-basis currency.

5. The method of claim 1, wherein the investment transaction includes buying an amount of each non-basis currency against the basis currency.

6. The method of claim 5, further including determining the present value of the currency index.

7. The method of claim 6, wherein determining the present value of the currency index (CWI(t)) includes applying the following equation:
$$CWI ( t ) = {\sum }_{i = 1}^{X} w ( i ) * \frac{FxRate ( i , t )}{FxRate ( i , 0 )} ,$$
wherein x is the number of non-basis currencies, wherein w(i) is the amount of i-th non-basis currency bought, wherein FxRate(i, 0) is an exchange rate of the basis currency with respect to the i-th non-basis currency when the amount of the non-basis currency was bought, and wherein FxRate(i, t) is a present exchange rate of the basis currency with respect to the i-th non-basis currency.

8. The method of claim 1, wherein the allocation is based at least in part on the relative gross domestic products of the countries that use the non-basis currencies.

9. The method of claim 1, wherein the allocation is based at least in part on the relative international trade volumes of the countries that use the non-basis currencies.

10. The method of claim 1, wherein the allocation is based at least in part on the exchange trading volumes of the countries that use the non-basis currencies.

11. A method of using a computer to determine the present value of a currency index of a basis currency against a plurality of non-basis currencies, wherein an investment transaction for each non-basis currency was initially made, the method including:
applying the following equation to determine the present value of the currency index (CI(t)):
$$C I ( t ) = {\sum }_{i = 1}^{X} w ( i ) * \frac{Rate ( i , t )}{Rate ( i , 0 )} ,$$
wherein x is the number of non-basis currencies, wherein w(i) is an amount of an initial investment transaction for the i-th non-basis currency, wherein Rate(i, 0) is an exchange rate for the basis currency and the i-th non-basis currency when the initial investment transaction occurred, and wherein Rate(i, t) is a present exchange rate for the basis currency and the i-th non-basis currency.

12. The method of claim 11, wherein the investment transaction includes selling an amount of the non-basis currency against the basis currency, and wherein the exchange rates are of the basis currency with respect to the non-basis currencies.

13. The method of claim 11, wherein the investment transaction includes buying an amount of the non-basis currency against the basis currency, and wherein the exchange rates are of the non-basis currencies with respect to the basis currency.

14. The method of claim 11, wherein the investment transaction for each non-basis currency was based at least in part on an assigned allocation.

15. The method of claim 14, wherein the allocation is based at least in part on the relative gross domestic products of the countries that use the non-basis currencies.

16. The method of claim 14, wherein the allocation is based at least in part on the relative international trade volumes of the countries that use the non-basis currencies.

17. The method of claim 14, wherein the allocation is based at least in part on the exchange trading volumes of the countries that use the non-basis currencies.

18. A computer-readable storage medium encoded with a set of instructions for execution on a processing device and associated processing logic for determining the present value of a currency index of a basis currency against a plurality of non-basis currencies, wherein an investment transaction for each non-basis currency was initially made, the set of instructions comprising:
a routine that allows the following equation to be applied to determine the present value of the currency index (CI(t)):
$$C I ( t ) = {\sum }_{i = 1}^{X} w ( i ) * \frac{Rate ( i , t )}{Rate ( i , 0 )} ,$$
wherein x is the number of non-basis currencies, wherein w(i) is an amount of an initial investment transaction for the i-th non-basis currency, wherein Rate(i, 0) is an exchange rate for the basis currency and the i-th non-basis currency when the initial investment transaction occurred, and wherein Rate(i, t) is a present exchange rate for the basis currency and the i-th non-basis currency.

19. The medium and instructions of claim 18, wherein the investment transaction includes selling an amount of the non-basis currency against the basis currency, and wherein the exchange rates are of the basis currency with respect to the non-basis currencies.

20. The medium and instructions of claim 18, wherein the investment transaction includes buying an amount of the non-basis currency against the basis currency, and wherein the exchange rates are of the non-basis currencies with respect to the basis currency.
